(19) United States
(12) Patent Application Publication
(10) Pub. No.: US 2025/0219674 A1
(43) Pub. Date: Jul. 3, 2025

(54) WIRELESS COMMUNICATION DEVICE AND A METHOD FOR WIRELESS COMMUNICATION

(71) Applicant: SAMSUNG ELECTRONICS CO., LTD., SUWON-SI (KR)

(72) Inventors: Hede PENG, Shenzhen (CN); Hanzhen WU, Shenzhen (CN)

(73) Assignee: Samsung Semiconductor China Research & Development Co., LTD, Suzhou (CN)

(21) Appl. No.: 18/432,170

(22) Filed: Feb. 5, 2024

(30) Foreign Application Priority Data
Dec. 29, 2023 (CN) 202311850160.0

(51) Int. Cl. H04B 1/44; H04B 1/00; H04B 7/06

(52) U.S. Cl. CPC H04B 1/44; H04B 1/0064; H04B 7/0691

(57) ABSTRACT

A wireless communication device including: a radio frequency integrated circuit (RFIC), including n signal processing modules, a switching module and n communication ports; an antenna switch module; and an antenna array, including m antennas, wherein each of the n signal processing modules is configured to process a signal to be transmitted from the signal processing module and a signal that is received by the signal processing module, wherein the switching module is configured to be connected between the n signal processing modules and the n communication ports and connects one of the n signal processing modules to one of the n communication ports, wherein each of the n communication ports is connected to at least one of the m antennas through the antenna switch module, and n and m are integers greater than 1.

### CROSS-REFERENCE TO RELATED APPLICATION

This application claims priority under 35 U.S.C. § 119 to Chinese Patent Application No. 202311850160.0 filed on Dec. 29, 2023, the disclosure of which is incorporated by reference herein in its entirety.

### TECHNICAL FIELD

The present disclosure generally relates to an electronic communication field, and more specifically, to a wireless communication device and a method for wireless communication.

### DISCUSSION OF RELATED ART

Currently, 5G mobile devices are required to support increasingly diverse functions and are becoming more intelligent. However, the complexity of the antenna environment and high costs remain significant challenges for mobile devices.

In the existing antenna design approach, signal transceiver pathway switching is implemented at the radio frequency front-end (RFFE). This process requires numerous complex switches, leading to high costs. Additionally, the design of the RFFE's transceiver pathway is complex, resulting in significant front-end insertion loss. Consequently, optimization of radio frequency performance is a challenge.

### SUMMARY

According to an example embodiment of the present disclosure, there is provided a wireless communication device including: a radio frequency integrated circuit (RFIC), including n signal processing modules, a switching module and n communication ports; an antenna switch module; and an antenna array, including m antennas, wherein each of the n signal processing modules is configured to process a signal to be transmitted from the signal processing module and a signal that is received by the signal processing module, wherein the switching module is configured to be connected between the n signal processing modules and the n communication ports and connects one of the n signal processing modules to one of the n communication ports, wherein each of the n communication ports is connected to at least one of the m antennas through the antenna switch module, and n and m are integers greater than 1.

According to an example embodiment of the present disclosure, there is provided a method for wireless communication including: processing, through each of n signal processing modules, a signal to be transmitted and a signal that is received; connecting, through a switching module, one of n signal processing modules to one of n communication ports; and connecting, through an antenna switch module, each of the n communication ports to at least one of m antennas included in an antenna array, wherein the n signal processing modules, the switching module and the n communication ports are included in a radio frequency integrated circuit (RFIC), and the antenna switch module and the antenna array are outside the RFIC, and wherein n and m are integers greater than 1

### BRIEF DESCRIPTION OF THE DRAWINGS

The above and other features of the present disclosure will become more apparent through the following detailed description together with the accompanying drawings in which:

FIG. 1 is a schematic diagram of a radio frequency front-end (RFFE) architecture in the related art;

FIG. 2 is a diagram of a wireless communication device including a RFFE architecture according to an example embodiment of the present disclosure;

FIGS. 3, 4, and 5 are diagrams of the radio frequency integrated circuit (RFIC) in FIG. 2 according to an example embodiment of the present disclosure, respectively;

FIGS. 6A, 6B and 6C are circuit connections and signal flow diagrams in the wireless communication device in FIG. 2 according to an example embodiment of the present disclosure.

FIG. 7 illustrates circuit connections and signal flow diagrams in the wireless communication device in FIG. 2 according to an example embodiment of the present disclosure;

FIG. 8 illustrates circuit connections and signal flow diagrams in the wireless communication device in FIG. 2 according to an example embodiment of the present disclosure; and

FIG. 9 illustrates a block diagram of a user equipment (UE) according to an example embodiment of the present disclosure.

### DETAILED DESCRIPTION OF THE EMBODIMENTS

The following detailed description is provided to assist the reader in gaining an understanding of the methods, apparatuses, and/or systems described herein. However, various changes, modifications, and equivalents of the methods, apparatuses, and/or systems described herein will be apparent after an understanding of the present disclosure. For example, the sequences of operations described herein are merely examples, and are not limited to those set forth herein. Thus, the sequences of operations described herein may be changed as will be apparent after an understanding of disclosure of the present application, with the exception of operations required to occur in a certain order. In addition, descriptions of features that are known in the art may be omitted for increased clarity and conciseness.

Although terms “first” or “second” may be used to explain various components, the components are not limited to the terms. These terms should be used to distinguish one component from another component. In addition, a “first” component may be referred to as a “second” component, or similarly, and the “second” component may be referred to as the “first” component.

It will be understood that when a component is referred to as being “connected to” another component, the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising”, when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical or scientific terms used herein have the same meaning as commonly understood by one of ordinary skill in the art to which example embodiments of the present disclosure belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings. It is noted that the same elements or similar elements may be designated by the same reference numerals or similar reference numerals, and redundant descriptions thereof may be omitted.

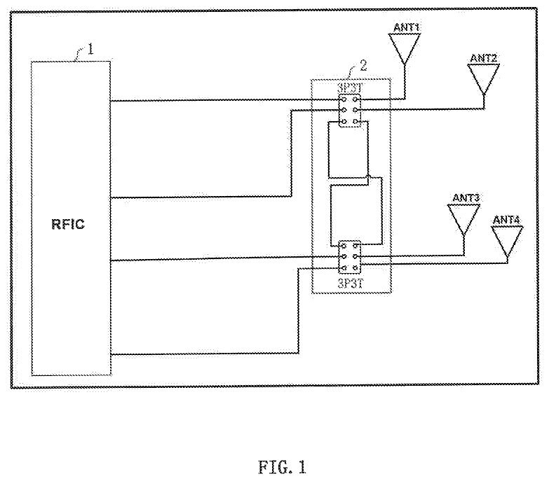

FIG. 1 is a schematic diagram of a radio frequency front-end (RFFE) architecture in the related art. Referring to FIG. 1, the RFFE architecture includes a radio frequency integrated circuit (RFIC) 1, an antenna switch module 2, and a plurality of antennas ANT1, ANT2, ANT3 and ANT4. During a communication process, the RFIC 1 switches to the plurality of antennas ANT1 to ANT4 respectively through the antenna switch module 2. This switching is usually implemented at the RFFE, and the antenna switch module 2 is implemented using a plurality of combiners or multi-pole multi-throw switches (for example, two three-pole three-throw switches 3P3T coupled to each other in FIG. 1). Implementing the antenna switch module 2 in this manner results in relatively high costs. Moreover, the design of the RFFE transceiver pathway is complex, and it suffers from significant insertion loss, posing a challenge in optimizing RF performance.

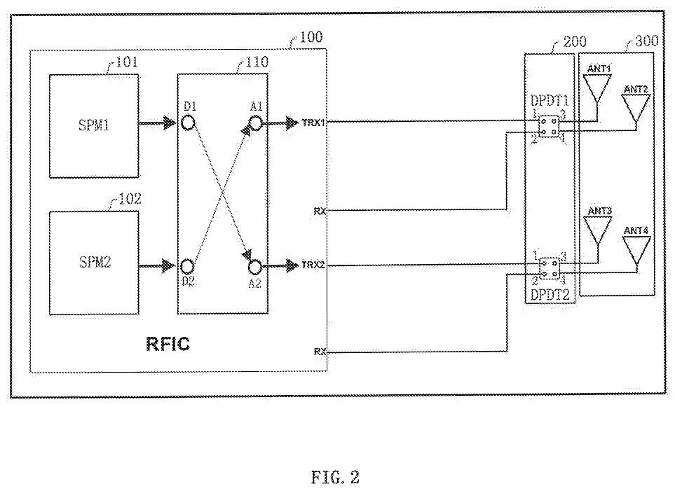

FIG. 2 is a diagram of a wireless communication device including a RFFE architecture according to an example embodiment of the present disclosure. In addition, in at least some example embodiments of the present disclosure, the wireless communication device may also include other components that are not shown.

The wireless communication device may include a RFIC 100, an antenna switch module 200, and an antenna array 300.

The RFIC 100 may have a plurality of communication ports. The communication ports may include at least one of the transmitting ports (TX), receiving ports (RX), and transceiver ports (TRX). In some example embodiments, the RFIC 100 may also include other components not shown.

In some example embodiments, the wireless communication device may also include a power amplifier (PA) module disposed between each of the transmitting ports TX and/or transceiver ports TRX of the RFIC 100 and the antenna switch module 200. The power amplifier (PA) module may amplify a radio frequency signal to have a sufficient radio frequency output power to be transmitted by an antenna.

In an example embodiment, RFIC 100 may include one or more signal processing modules. In an embodiment, RFIC 100 may also include a switching module 110. For the convenience of description, FIG. 2 shows two signal processing modules (e.g., a first signal processing module (SPM1) 101 and a second signal processing module (SPM2) 102). Additionally or alternatively, the number of signal processing modules is not limited thereto and may be set as needed.

The antenna array 300 may include a plurality of antennas (e.g., antennas ANT1, ANT2, ANT3 and ANT4) or a plurality of groups of antennas. In this case, each group of antennas includes two or more antennas, such as a first antenna group including antennas ANT1 and ANT2 and a second antenna group including antennas ANT3 and ANT4. The plurality of antennas or groups of antennas in the antenna array 300 may be used to cover a single frequency band or multiple communication frequency bands. The antenna array 300 may be implemented as one or more of a multi-frequency antenna, an array antenna, or an on-chip antenna. The plurality of antennas or groups of antennas in the antenna array 300 are used to transmit and receive electromagnetic wave signals (e.g., radio frequency signals).

Each signal processing module, e.g., 101 and 102, may process a signal to be transmitted and a received signal. When the wireless communication device transmits a signal, the signal processing module may receive a baseband signal and convert the received baseband signal into a transmitted signal (e.g., a radio frequency signal). In this case, the transmitted signal is transferred to a corresponding switch in the antenna switch module 200, and then transmitted from a corresponding antenna in the antenna array 300. A path of the transmitted signal to the antenna switch module 200 via the switching module 110 may be referred to as a transmission pathway (or a transmission path, a transmission link and the like).

When a wireless communication device receives a signal, the antenna array 300 may send the received signal (e.g., a radio frequency signal) to the antenna switch module 200. Then antenna switch module 200 then sends the radio frequency signal to the RFIC 100, and the signal processing modules, e.g., 101 and 102, in the RFIC 100 convert the radio frequency signal into a baseband signal. A path of the radio frequency signal sent to the signal processing modules in the RFIC 100 via the antenna switch module 200 and the switching module 110 may be referred to as a reception pathway (or a reception path, a reception link and the like).

A port coupled to the transmission pathway in the RFIC 100 is the transmitting port TX, and a port coupled to the reception pathway in the RFIC 100 is the receiving port RX. FIG. 2 shows communication ports including transceiver ports (for example, a first transceiver port TRX1 and a second transceiver port TRX2) and receiving ports (for example, two receiving ports RX). The transceiver ports (for example, the first transceiver port TRX1 and the second transceiver port TRX2) may serve as integrated ports for the transmission and reception pathways, functioning to transmit and receive signals. The receiving port RX may only be used to receive signals received via the antenna array 300. In some example embodiments, the signal received from the antenna array 300 may be input to the receiving port RX via for example the antenna switch module 200 and a low noise amplifier (LNA). Additionally or alternatively, the specific configuration and number of communication ports may not be limited to the example shown in FIG. 2 and may be set and adjusted as needed.

The switching module 110 may be connected between a plurality of signal processing modules (e.g., signal processing modules 101 and 102) and a plurality of transceiver ports (e.g., transceiver ports TRX1 and TRX2), and is used to connect one of the plurality of signal processing modules, e.g., 101 and 102, to one of the plurality of transceiver ports, e.g., TRX1 and TRX2. For example, as shown in FIG. 2, the switching module 110 may include first terminals D1 and D2 and second terminals A1 and A2. The terminal D1 of the switching module 110 may be connected to the terminal A1 or A2, and the terminal D2 of the switching module 110 may be connected to the terminal A1 or A2. In the case where the terminal D1 and terminal A1 of the switching module 110 are connected, the signal processed by the first signal processing module 101 may be output to the first transceiver port TRX1 via the switching module 110, or the signal received from the first transceiver port TRX1 may be transferred to the first signal processing module 101 via the switching module 110. In the case where the terminal D1 and terminal A2 of the switching module 110 are connected, the signal processed by the first signal processing module 101 may be output to the second transceiver port TRX2 via the switching module 110, or the signal received from the second transceiver port TRX2 may be transferred to the first signal processing module 101 via the switching module 110. In other words, the switching module 110 provided in the RFIC 100 may switch among the transmission pathways and/or reception pathways inside the RFIC 100 as needed.

Compared with the antenna switch module in FIG. 1, the antenna switch module 200 in FIG. 2 may be implemented by, for example, switch modules of two independent double-pole double-throw (DPDT). According to an example embodiment, by implementing the switching module 110 for switching among the transmission pathways and/or the reception pathways inside the RFIC 100, the circuit design and wiring of the RFFE may be optimized.

The antenna switch module 200 may connect the plurality of transceiver ports (for example, transceiver ports TRX1 and TRX2) to at least one antenna included in the antenna array 300. For example, the signal transmitted from the first transceiver port TRX1 may be transmitted from the first antenna ANT1 or the second antenna ANT2 in the antenna array 300 via a first double-pole double-throw switch DPDT1 in the antenna switch module 200. The signal received from the first antenna ANT1 or the second antenna ANT2 may be input to the first transceiver port TRX1 or the first receiving port RX via the first double-pole double-throw switch DPDT1 in the antenna switch module 200. This way the signal can be processed by a corresponding signal processing module in the RFIC 100. For example, the signal transmitted from the second transceiver port TRX2 may be transmitted from the third antenna ANT3 or the fourth antenna ANT4 in the antenna array 300 via a second double-pole double-throw switch DPDT2 in the antenna switch module 200. In contrast, the signal received from the third antenna ANT3 or the fourth antenna ANT4 may be input to the second transceiver port TRX2 or the second receiving port RX via the second double-pole double-throw switch DPDT2 in the antenna switch module 200. This way the signal can be processed by a corresponding signal processing module in the RFIC 100.

According to an example embodiment, since the RFIC 100 internally realizes the mutual switching output among the plurality of transceiver ports, e.g., TRX1 and TRX2, through the switching module 110, the RFFE might not have to establish the transmission pathway from each transceiver port, e.g., TRX1 and TRX2, to all antennas in the antenna array 300 through a complex antenna switch module. In other words, according to the wireless communication device of the example embodiment, the complexity of the front-end architecture design is reduced, the layout flexibility is improved, the RFFE architecture is simple, the overall system cost is reduced. Furthermore, the front-end link insertion loss is optimized, and RF performance and user experience are improved.

According to an example embodiment, the RFIC 100 and the wireless communication device including the RFIC 100 may be applied to terminal devices, such as mobile phones, tablet computers, wearable devices, on-board devices, smart cars, augmented reality (AR)/virtual reality (VR) devices, notebook computers, ultra mobile personal computers (UMPC), netbooks, personal digital assistants (PDA), smart TVs, etc., and the types of the terminal devices are not limited thereto.

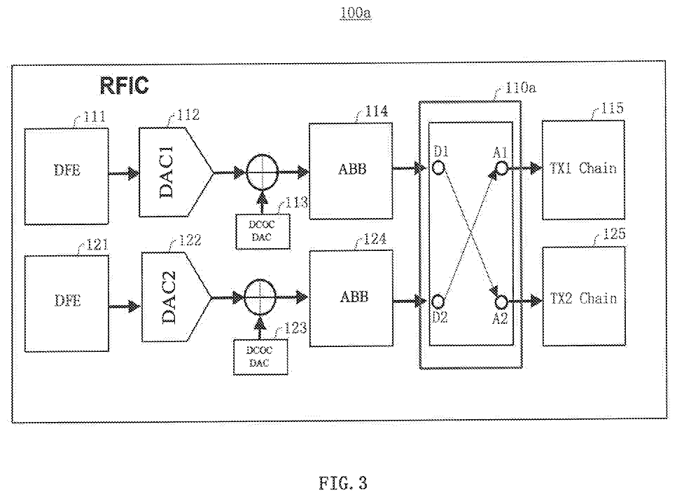

FIGS. 3, 4, and 5 are diagrams of the RFIC in FIG. 2 according to an example embodiment of the present disclosure, respectively.

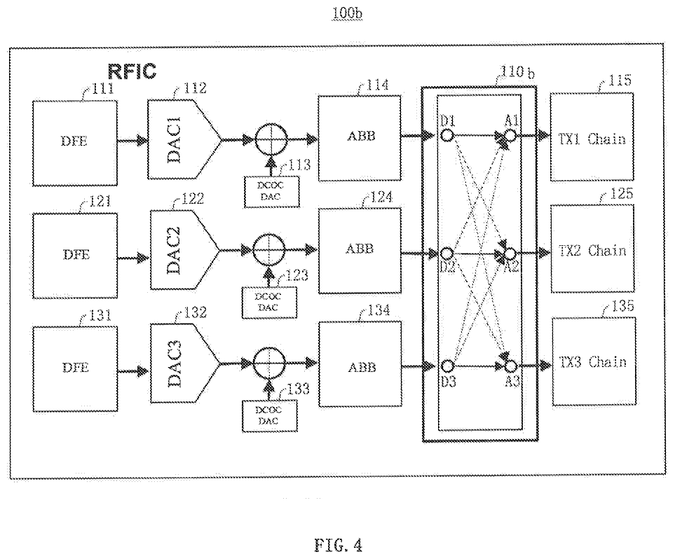

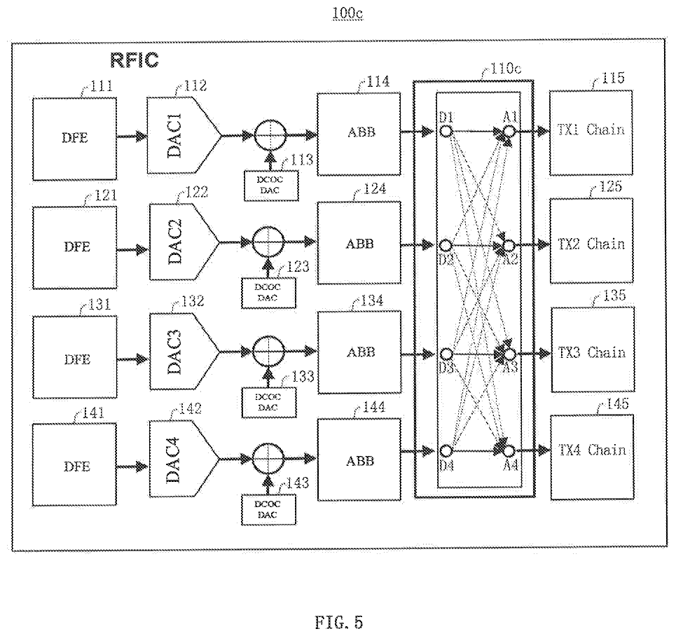

FIG. 3 shows an example of a switching module 110a in a RFIC 100a, and the switching module 110a may be implemented with a double-pole double-throw switch DPDT. FIG. 4 shows another example of a switching module 110b in a RFIC 100b, and the switching module 110b may be implemented with a three-pole three-throw switch 3P3T. FIG. 5 shows another example of a switching module 110c in a RFIC 100c, and the switching module 110c may be implemented with a four-pole four-throw switch 4P4T. However, the implementation of the switching module 110 in FIG. 2 is not limited thereto.

The RFIC 100a in FIG. 3 may include a plurality of signal processing modules SPM, a switching module 110a, and a plurality of transmission chains (e.g., a first transmission chain (TX1 Chain) 115 and a second transmission chain (TX2 Chain) 125). The plurality of signal processing modules SPM (for example, the signal processing modules SPM1 and SPM2 in FIG. 2) may include a decision feedback equalizer DFE (for example, a first decision feedback equalizer 111 and a second decision feedback equalizer 121), a digital-to-analog converter DAC (for example, a first digital-to-analog converter DAC1 112 and a second digital-to-analog converter DAC2 122), an analog baseband signal processing module ABB (for example, a first analog baseband signal processing module 114 and a second analog baseband signal processing module 124). The above configuration is provided as an example only, and the components included in FIG. 3 are not limited thereto. For example, some of the components may be omitted, some components may be added, or some of the components may be replaced by other components that may achieve similar functions.

The decision feedback equalizer DFE (e.g., the first decision feedback equalizer 111) may compensate for an input signal (e.g., a baseband signal) to eliminate inter-signal interference. The signal output from the decision feedback equalizer DFE (e.g., the first decision feedback equalizer 111) may be input to the digital-to-analog converter DAC (e.g., the first digital-to-analog converter 112) to output an analog signal processed by digital-to-analog conversion (e.g., an analog baseband signal). The signal output from the digital-to-analog converter DAC (e.g., the first digital-to-analog converter 112) may be superimposed with the analog signal output from a direct-current offset cancellation (DCOC) module 113. For example, the analog baseband signal may be superimposed with the analog signal output from a direct-current offset cancellation (DCOC) module 113. The superimposed signal may then be input to the analog baseband signal processing module ABB (e.g., the first analog baseband signal processing module 114) to output the corresponding RF signal. The DCOC module 113 may negate the impact of its own operational amplifier offset voltage and flicker noise on the signal. The analog baseband signal processing module ABB may be connected to the transmission chains through the switching module 110a. For example, when the terminals D1 and A1 of the switching module 110a are connected, the RF signal processed by the first analog baseband signal processing module 114 may be output to the first transmission chain 115 (e.g., output to the first transceiver port TRX1). As another example, when the terminals D1 and A2 of the switching module 110a are connected, the RF signal processed by the first analog baseband signal processing module 114 may be output to the second transmission chain 125 (e.g., output to the second transceiver port TRX2).

The difference between the RFICs 100b and 100c in FIGS. 4 and 5 and the RFIC 100a in FIG. 3 may lie in the specific structure of the switching module and the number of corresponding components. Therefore, repeated descriptions will be omitted to avoid redundancy.

The switching module 110b in FIG. 4 may include first terminals D1 to D3 and second terminals A1 to A3. For example, the switching module 110b in FIG. 4 may be controlled to connect one of the first terminals (e.g., D2) to any one of the second terminals (e.g., any one of A1 to A3), to achieve the switching among the RF signal transmission pathways and/or reception pathways inside the RFIC 100b. The decision feedback equalizers DFEs 111, 121, and 131 in FIG. 4 may have substantially the same or similar structure and functions as the decision feedback equalizers DFEs 111 and 121 in FIG. 3, the digital-to-analog converters DAC1-DAC3 112, 122, and 132 in FIG. 4 may have substantially the same or similar structure and functions as the digital-to-analog converters DAC1 and DAC2 112 and 122 in FIG. 3, the analog baseband signal processing modules ABB 114, 124, and 134 in FIG. 4 may have substantially the same or similar structure and functions as the analog baseband signal processing modules ABB 114 and 124 in FIG. 3, the DCOC modules 113, 123 and 133 in FIG. 4 may have substantially the same or similar structure and functions as the DCOC modules 113 and 123 in FIG. 3. In addition, the transmission chains 115, 125 and 135 in FIG. 4 may have substantially the same or similar structure and functions as the transmission chains 115 and 125 in FIG. 3.

In addition, the switching module 110c in FIG. 5 may include first terminals D1 to D4 and second terminals A1 to A4. For example, the switching module 110c in FIG. 5 may be controlled to connect one of the first terminals (e.g., D1) to any one of the second terminals (e.g., any one of A1 to A4), to achieve the switching among the RF signal transmission pathways and/or reception pathways inside the RFIC 100c. The decision feedback equalizers DFEs 111, 121, 131 and 141 in FIG. 5, the digital-to-analog converters DAC1-DAC4 112, 122, 132 and 142 in FIG. 5, the analog baseband signal processing modules ABB 114, 124, 134 and 144 in FIG. 5, the DCOC modules 113, 123, 133 and 143 in FIG. 5, and the transmission chains 115, 125, 135 and 145 in FIG. 5 may be similarly set according to the corresponding descriptions regarding FIGS. 3 and 4 above.

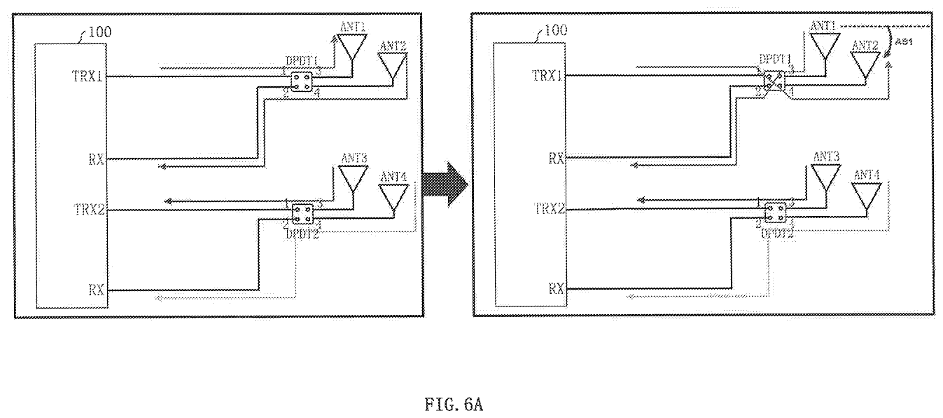

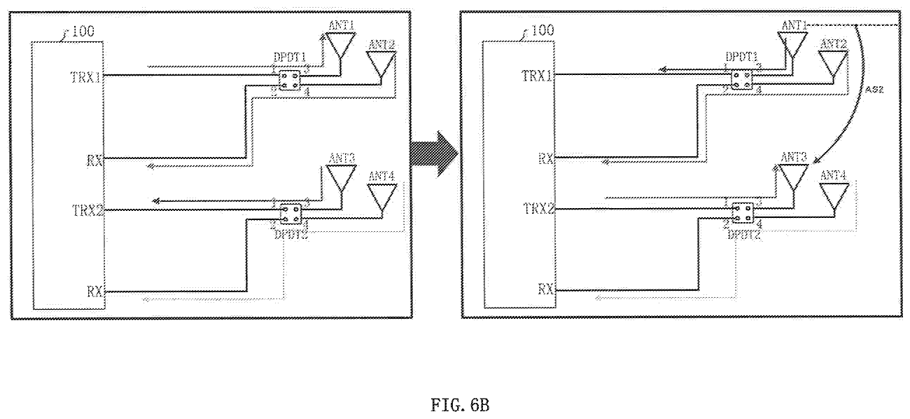

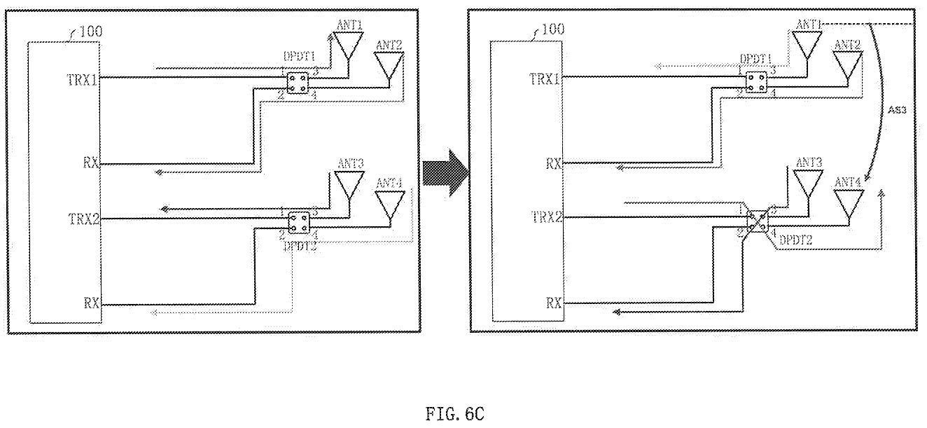

FIGS. 6A, 6B and 6C are circuit connections and signal flow diagrams in the wireless communication device in FIG. 2 according to an example embodiment of the present disclosure.

Radio frequency circuits may be used in 5th Generation Mobile Communication Technology (5G). In addition, because of the network evolution of the 4th Generation Mobile Communication Technology (4G) to 5G, the 5G networking model may be divided into non-independent networking NSA and independent networking SA. In the non-independent networking NSA mode, with the help of the current 4G core network, the 4G base station is the main station and the 5G base station is the auxiliary station. In the independent networking SA mode, only the 5G base station is connected to the 5G core network. For 5G terminals, it is necessary to support both the independent SA and the non-independent NSA networking modes. In addition, the radio frequency circuit in the present embodiment may support two networking modes, the non-independent NSA and the independent SA.

The wireless communication device according to an example embodiment may communicate with one or more base stations that may communicate using different radio access technologies and/or different frequency resources. The wireless communication device may include a plurality of antennas in an antenna array, wherein one or more of the plurality of antennas may be used to communicate with the base station using Antenna Switch Diversity (ASDiv). For example, this method involves using multiple antennas to select the best antenna configuration when the current configuration uses an antenna that does not meet the desired radio condition (for example, the current antenna is obscured by the user's hand or other obstacles, etc.). This technique can improve signal quality and reliability.

The wireless communication device according to the example embodiment may support the ASDiv switching function in 4G long-term evolution (LTE) mode (for example, the 4-way ASDiv switching function in the low/medium/high frequency band), and support the ASDiv switching function in the 5G new radio (NR) mode (for example, the 4-Way ASDiv switching function in the low/medium/high frequency band). FIGS. 6A to 6C show the circuit connection and signal flow direction of the wireless communication device according to the example embodiment in the case of ASDiv switching.

In FIGS. 6A to 6C, for ease of description, the number of antennas is assumed to be found, and the first antenna ANT1 is used as an example of an antenna used to transmit and receive signals in a working scenario. However, example embodiments according to the present disclosure are not limited thereto, the number of antennas and the usage configuration of each antenna may be set as needed. FIG. 6A shows the ASDiv switching scenario between the first antenna ANT1 and the second antenna ANT2, FIG. 6B shows the ASDiv switching scenario between the first antenna ANT1 and the third antenna ANT3, and FIG. 6C shows the ASDiv switching scenario between the first antenna ANT1 and the fourth antenna ANT4.

The first switch (DPDT1) may include a first terminal 1, a second terminal 2, a third terminal 3 and a fourth terminal 4. The first transceiver port TRX1 may be connected to the first terminal 1 of the first switch (DPDT1), the first receiving port RX in the RFIC 100 may be connected to the second terminal 2 of the first switch (DPDT1), the third terminal 3 of the first switch (DPDT1) may be connected to the first antenna ANT1, and the fourth terminal 4 of the first switch (DPDT1) may be connected to the second antenna ANT2. The second switch (DPDT2) may include a first terminal 1, a second terminal 2, a third terminal 3 and a fourth terminal 4. The second transceiver port TRX2 may be connected to the first terminal 1 of the second switch (DPDT2), the second receiving port RX in the RFIC 100 may be connected to the second terminal 2 of the second switch (DPDT2), the third terminal 3 of the second switch (DPDT2) may be connected to the third antenna ANT3, and the fourth terminal 4 of the second switch (DPDT2) may be connected to the fourth antenna ANT4.

Before the ASDiv switching, the transmitted signal output from the signal processing module in the RFIC 100 may be output from the first transceiver port TRX1 via the switching module (for example, the switching module 110 in FIG. 2), and the transmitted signal output from the first transceiver port TRX1 may be transferred to the first switch (DPDT1) in the antenna switch module (the antenna switch module 200 in FIG. 2), and transmitted through the first antenna ANT1 in the antenna array (the antenna array 300 in FIG. 3). This signal flow is illustrated by the uppermost arrow on the left side of FIG. 6A. In addition, the circuit connection of the received signal via the first antenna ANT1 may be similar to the case of transmitting the signal via the first antenna ANT1 described above, but the signal flow in both cases is opposite. In this case, the first switch (DPDT1) may be controlled to connect its first terminal 1 to its third terminal 3, so that the transmitted signal output from the first transceiver port TRX1 is transmitted via the first antenna ANT1. At this time, the second antenna ANT2 to the fourth antenna ANT4 may be used to receive signals. For example, the signal received from the second antenna ANT2 may be transferred to the first receiving port RX via the first switch (DPDT1) in the antenna switch module (the antenna switch module 200 in FIG. 2), the signal received from the third antenna ANT3 may be transferred to the second transceiver port TRX2 via the second switch (DPDT2) in the antenna switch module (the antenna switch module 200 in FIG. 2), and the signal received from the fourth antenna ANT4 may be transferred to the second receiving port RX via the second switch (DPDT2) in the antenna switch module (the antenna switch module 200 in FIG. 2). These signal flow are illustrated by the arrows pointing to the left on the left side of FIG. 6A.

As shown in FIG. 6A, the circuit connection and signal flow direction in the ASDiv switching scenario of switching from the first antenna ANT1 to the second antenna ANT2 are as follows: the transmitted signal output from the signal processing module in the RFIC 100 may be output from the first transceiver port TRX1 via the switching module (for example, the switching module 110 in FIG. 2), the transmitted signal output from the first transceiver port TRX1 may be transferred to the first switch (DPDT1), the first switch (DPDT1) may be controlled to disconnect its first terminal 1 from its third terminal 3 and connect its first terminal 1 to its fourth terminal 4, so that the transmitted signal output from the first transceiver port TRX1 is transmitted via the second antenna ANT2 (see right side of FIG. 6A). In addition, the circuit connection for receiving a signal (e.g., AS1) via the second antenna ANT2 after ASDiv switching may be similar to the situation described above for transmitting a signal via the second antenna ANT2 after ASDiv switching, but the signal flow in both cases is opposite. At this time, the first antenna ANT1, the third antenna ANT3 and the fourth antenna ANT4 may be used to receive signals. For example, the signal received from the first antenna ANT1 may be transferred to the first receiving port RX via the first switch (DPDT1) in the antenna switch module (the antenna switch module 200 in FIG. 2), the signal received from the third antenna ANT3 may be transferred to the second transceiver port TRX2 via the second switch (DPDT2) in the antenna switch module (the antenna switch module 200 in FIG. 2), and the signal received from the fourth antenna ANT4 may be transferred to the second receiving port RX via the second switch (DPDT2) in the antenna switch module (the antenna switch module 200 in FIG. 2). These signal flows are illustrated by the arrows pointing to the left on the right side of FIG. 6A.

As shown in FIG. 6B, the circuit connection and signal flow direction in the ASDiv switching scenario of switching from the first antenna ANT1 to the third antenna ANT3 are as follows: the transmitted signal output from the signal processing module in the RFIC 100 may be output from the second transceiver port TRX2 via the switching module (for example, the switching module 110 in FIG. 2), the transmitted signal output from the second transceiver port TRX2 may be transferred to the second switch (DPDT2), the second switch (DPDT2) may be controlled to connect its first terminal 1 to its third terminal 3, so that the transmitted signal output from the transceiver port TRX2 is transmitted via the third antenna ANT3. This signal flow is shown on the right side of FIG. 6B. In addition, the circuit connection for receiving a signal (e.g., AS2) via the third antenna ANT3 after ASDiv switching may be similar to the situation described above for transmitting a signal via the third antenna ANT3 after ASDiv switching, but the signal flow in both cases is opposite. At this time, the first antenna ANT1, the second antenna ANT2 and the fourth antenna ANT4 may be used to receive signals. For example, the signal received from the first antenna ANT1 may be transferred to the first transceiver port TRX1 via the first switch (DPDT1) in the antenna switch module (the antenna switch module 200 in FIG. 2), the signal received from the second antenna ANT2 may be transferred to the first receiving port RX via the first switch (DPDT1) in the antenna switch module (the antenna switch module 200 in FIG. 2), and the signal received from the fourth antenna ANT4 may be transferred to the second receiving port RX via the second switch (DPDT2) in the antenna switch module (the antenna switch module 200 in FIG. 2). These signal flows are illustrated by the arrows pointing to the left on the right side of FIG. 6B.

As shown in FIG. 6C, the circuit connection and signal flow direction in the ASDiv switching scenario of switching from the first antenna ANT1 to the fourth antenna ANT4 are as follows: the transmitted signal output from the signal processing module in the RFIC 100 may be output from the second transceiver port TRX2 via the switching module (for example, the switching module 110 in FIG. 2), the transmitted signal output from the second transceiver port TRX2 may be transferred to the second switch (DPDT2), the second switch (DPDT2) may be controlled to disconnect its first terminal 1 from its third terminal 3 and connect its first terminal 1 to its fourth terminal 4, so that the transmitted signal output from the second transceiver port TRX2 is transmitted via the fourth antenna ANT4. This signal flow is shown on the right side of FIG. 6C. In addition, the circuit connection for receiving signals (e.g., AS3) via the fourth antenna ANT4 after ASDiv switching may be similar to the situation described above for transmitting signals via the fourth antenna ANT4 after ASDiv switching, but the signal flow in both cases is opposite. At this time, the first antenna ANT1 to the third antenna ANT3 may be used to receive signals. For example, the signal received from the first antenna ANT1 may be transferred to the first transceiver port TRX1 via the first switch (DPDT1) in the antenna switch module (the antenna switch module 200 in FIG. 2), the signal received from the second antenna ANT2 may be transferred to the first receiving port RX via the first switch (DPDT1) in the antenna switch module (the antenna switch module 200 in FIG. 2), and the signal received from the third antenna ANT3 may be transferred to the second receiving port RX via the second switch (DPDT2) in the antenna switch module (the antenna switch module 200 in FIG. 2). These signal flows are illustrated by the arrows pointing to the left on the right side of FIG. 6C.

In the example embodiment of the present application, the switch at the RFFE used to switch among the antennas used for transmission does not need to be a four-pole four-throw switch (4P4T) or two three-pole three-throw switches coupled to each other, etc., which may reduce the path loss of the RF circuit and reduce the RF power consumption. In addition, in the RFIC provided with a switching module for switching among the transmission pathways and/or the reception pathways, the switch at the RFFE used to switch among the antennas used for transmission may be a double-pole double-throw switch (DPDT), etc., for example, from 4P4T to two DPDT), which may improve the flexibility of circuit design, as well as reduce cost, occupied area and path loss.

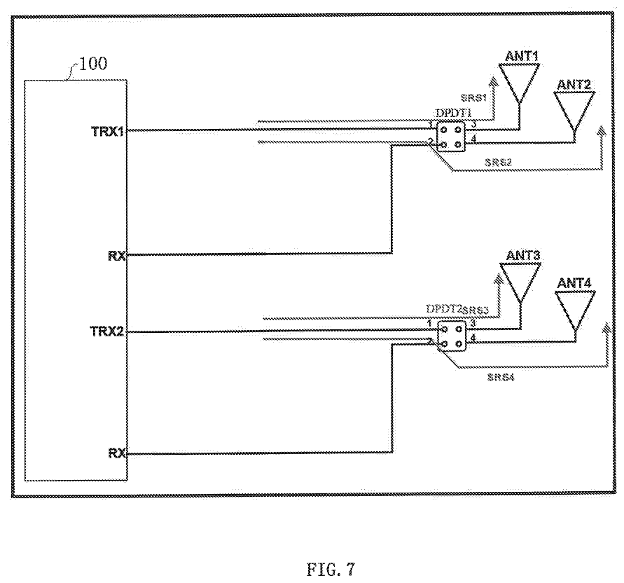

FIG. 7 is a circuit connection and signal flow diagram in the wireless communication device in FIG. 2 according to an example embodiment of the present disclosure.

The wireless communication device according to the example embodiment may support the Sounding Reference Signal (SRS) function in the NR SA mode (for example, the 1T4R SRS function in the n41 frequency band in the NR SA mode, etc.). Here, NR SA may stand for New Radio Independent (or Standalone). FIG. 7 shows the circuit connection and signal flow direction of the wireless communication device according to an example embodiment in the case of transmitting SRS.

The wireless communication device needs to have the ability to switch among multiple antennas when transmitting SRS to implement alternating SRS transmission.

As shown in FIG. 7, in the case of switching from an SRS1 path to an SRS2 path, the transmitted signal output from the first transceiver port TRX1 is transmitted from the second antenna ANT2 via the first switch (DPDT1). At this time, the switching module (for example, the switching module 110 in FIG. 2) is connected to the first transceiver port TRX1, and the first switch (DPDT1) connects the first transceiver port TRX1 to the second antenna ANT2.

As shown in FIG. 7, in the case of switching from the SRS1 path to the SRS3 path, the transmitted signal output from the second transceiver port TRX2 is transmitted from the third antenna ANT3 via the second switch (DPDT2). At this time, the switching module (for example, the switching module 110 in FIG. 2) is connected to the second transceiver port TRX2, and the second switch (DPDT2) connects the second transceiver port TRX2 to the third antenna ANT3.

As shown in FIG. 7, in the case of switching from the SRS1 path to the SRS4 path, the transmitted signal output from the second transceiver port TRX2 is transmitted from the fourth antenna ANT4 via the second switch (DPDT2). At this time, the switching module (for example, the switching module 110 in FIG. 2) is connected to the second transceiver port TRX2, and the second switch (DPDT2) connects the second transceiver port TRX2 to the fourth antenna ANT4.

The example embodiment of the present application realizes the switching among the transceiver ports for transmitting signal inside the RFIC of the RF circuit, which may reduce the complexity of the design and control of the antenna switch module outside the RFIC, thereby improving the flexibility of circuit design and reduce the path loss of the RF circuit.

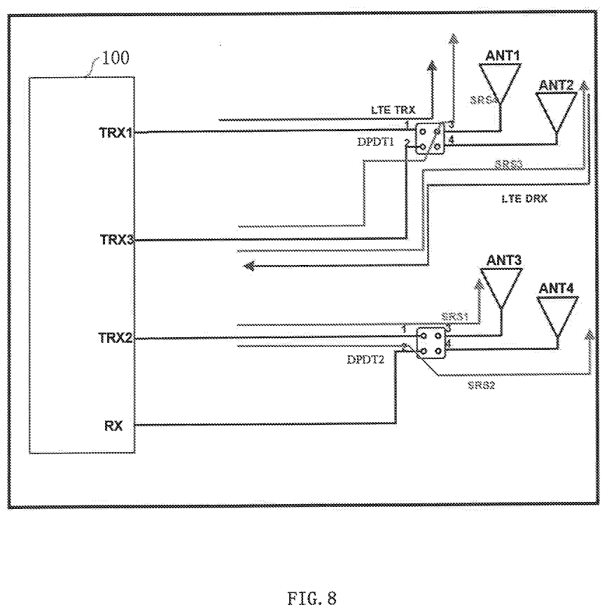

FIG. 8 is a circuit connection and signal flow diagram in the wireless communication device in FIG. 2 according to an example embodiment of the present disclosure. As shown in FIG. 8, the wireless communication device according to the example embodiment may include a RFIC 100, an antenna switch module including a first switch (DPDT1) and a second switch (DPDT2), and an antenna array including a first antenna ANAT1 to a fourth antenna ANT4. The RFIC 100 may include a plurality of signal processing modules and a switching module. The RFIC 100 in FIG. 8 may correspond to the RFIC 100b in FIG. 4. The RFIC 100 of FIG. 8 may also include transceiver ports TRX1 to TRX3 and a receiving port RX. The first transceiver port TRX1 and the third transceiver port TRX3 may be connected to two terminals (a first terminal 1 and a second terminal 2) of the first switch (DPDT1) in the antenna switch module 200, respectively, and the other two terminals (a third terminal 3 and a fourth terminal 4) of the first switch (DPDT1) are connected to the first antenna ANT1 and the second antenna ANT2, respectively. The second transceiver port TRX2 and the receiving port RX may be connected to two terminals (a first terminal 1 and a second terminal 2) of the second switch (DPDT2) in the antenna switch module 200, respectively, and the other two terminals of the second switch (DPDT2) (a third terminal 3 and a fourth terminal 4) may be connected to the third antenna ANT3 and the fourth antenna ANT4, respectively. In an embodiment, the RF signal output to the antenna array through the second transceiver port TRX2 and the third transceiver port TRX3 may be a transmitted signal of a first frequency band, and the RF signal output to the antenna array through the first transceiver port TRX1 may be a transmitted signal of a second frequency band. For example, the first frequency band may include a frequency band for 5G, etc., and the second frequency band may include a frequency band for 4G, etc.

The wireless communication device according to the example embodiment may support the ASDiv switching function (for example, the 4-Way ASDiv function) and the SRS function in the non-independent NSA mode.

As shown in FIG. 8, in the SRS1 path, the transmitted signal is output from the second transceiver port TRX2 through the switching module, and then transmitted from the third antenna ANT3 via the second switch (DPDT2).

In the case of switching from the SRS1 path to the SRS2 path, the transmitted signal is output from the second transceiver port TRX2 through the switching module, and then transmitted from the fourth antenna ANT4 via the second switch (DPDT2). At this time, the switching module (for example, the switching module 110 in FIG. 2) may be connected to the second transceiver port TRX2, and the second switch (DPDT2) may connect the second transceiver port TRX2 to the fourth antenna ANT4.

In the case of switching from the SRS1 path to the SRS3 path, the transmitted signal is output from the third transceiver port TRX3 through the switching module, and then transmitted from the second antenna ANT2 via the first switch (DPDT1). At this time, the switching module (for example, the switching module 110 in FIG. 2) may be connected to the third transceiver port TRX3, and the first switch (DPDT1) may connect the third transceiver port TRX3 to the second antenna ANT2. At this time, the path (NR TRX path) through which the transmitted and received signals of the first frequency band (for example, the 5G frequency band, etc.) flow and the path (LTE DRX path) through which the diversity reception signal of the second frequency band (for example, the 4G frequency band, etc.) flows may be the same. In addition, the path (LTE TRX path) through which the transmitted signal of the second frequency band flows and the above two paths (e.g., NR TRX path and LTE DRX path) may be different. In other words, both the NR TRX path and the LTE DRX path pass through the second antenna ANT2, and the LTE TRX path passes through the first antenna ANT1. This example embodiment may support the SRS function in the non-independent NSA mode without affecting the transmission and reception of the signals of the first frequency band and the signals of the second frequency band.

In the case of switching from the SRS1 path to the SRS4 path, the transmitted signal is output from the third transceiver port TRX3 through the switching module, and then transmitted from the first antenna ANT1 via the first switch (DPDT1). At this time, the switching module (for example, the switching module 110 in FIG. 2) is connected to the third transceiver port TRX3, and the first switch (DPDT1) connects the third transceiver port TRX3 to the first antenna ANT1. At this time, to avoid interrupting the transmitted signal of the second frequency band due to the conflict between the path (NR TRX path) through which the transmitted and received signals of the first frequency band (5G frequency band, etc.) flow and the path (LTE TRX path) through which the transmitted signals of the second frequency band (4G frequency band, etc.) flow, the path (LTE TRX path) through which the transmitted signals of the second frequency band output from the first transceiver port TRX1 travel may be switched by way of the first switch DPDT1 (e.g., the first terminal 1 of the first switch DPDT1 is connected to its fourth terminal 4) to the second antenna ANT2. Further, the path (LTE DRX path) through which the diversity reception signal of the second frequency band (long-term evolution frequency band, etc. of the 4G standard) flows may be switched from the second antenna ANT2 to the first antenna ANT1, and thus, the LTE TRX path passes through the second antenna ANT2. This example embodiment may ensure that the signal is completely received or transmitted when performing antenna switching in non-independent NSA mode.

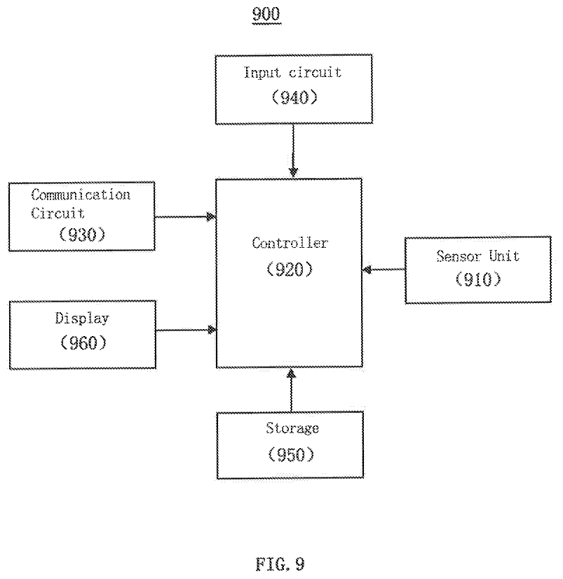

FIG. 9 illustrates a block diagram of user equipment (UE) according to an example embodiment of the present disclosure.

The UE 900 may be a cellular phone, a cordless phone, a Personal Digital Assistant (PDA) device, a handheld device with a wireless communication function, a computing device or other processing device connected to a wireless modem, a wearable device, an on-board device, an internet terminal of vehicle, a desktop computer, a laptop computer, a handheld communication apparatus, a handheld computing device, and/or other devices for communicating on a wireless system.

As shown in FIG. 9, the UE 900 according to some example embodiments may include a sensor unit (circuit) 910, a controller 920, a communication circuit 930, an input circuit 940, a storage 950, and a display 960. The UE 900 may further include additional circuits.

The sensor unit 910 may sense the environment of the UE 900.

The controller 920 may control the overall operation of the UE, and may control part or all of the internal elements of the UE. The controller 920 may be implemented as, for example, a general-purpose processor, an application processor (AP), an application specific integrated circuit and/or a field programmable gate array, but it is not limited thereto.

The communication circuit 930 may perform the communication operation of the UE 900 with another UE or a communication network. According to an example embodiment, the communication circuit 930 may establish a call to another UE under the control of the controller 920. For example, the communication circuit 930 may establish a call based on a first network in which it resides, and perform timing. The communication circuit 930 may determine whether a first command for handover or redirection to a second network is received from the first network. The communication circuit 930 may perform an autonomous redirection when it is determined that the first command is not received and the timed time reaches a predetermined time threshold, such that the UE 900 redirects to the second network and continues the call in the second network.

The input circuit 940 may receive various input information and control signals, and send the input information and control signals to the controller 920. The input circuit 940 may be implemented through various input devices such as a keypad and/or keyboard, a touch screen and/or a stylus, but is not limited thereto.

The storage 950 may include volatile memory and/or nonvolatile memory. The storage 950 may store various data generated and used by the UE 900. For example, the storage 950 may store an operating system, an application program (for example, an application program associated with a method according to an example embodiment of the present disclosure) for controlling the operation of the UE 900.

The display 960 may display various information based on the control of the controller 920.

According to some example embodiments, operations performed by the wireless communication device, a RFIC 100, etc., and a method for wireless communication described herein may be performed by a processing circuit. The term “processing circuit” as used in the present disclosure may refer to, for example, hardware including logic circuits, a hardware/software combination (such as a processor executing software), or a combination thereof. For example, the processing circuit may include, but is not limited to, a central processing unit (CPU), an arithmetic logic unit (ALU), a digital signal processor, a microcomputer, a field programmable gate array (FPGA), a system on a chip (SoC), programmable logic units, microprocessors, application specific integrated circuits (ASICs), etc.

The apparatuses, units, modules, devices, and other components described herein are implemented by hardware components. Examples of hardware components that may be used to perform the operations described in the present disclosure where appropriate include controllers, sensors, generators, drivers, memories, comparators, arithmetic logic units, adders, subtractors, multipliers, dividers, integrators, and any other electronic components configured to perform the operations described in the present disclosure. In other examples, one or more of the hardware components that perform the operations described in the present disclosure are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In an example embodiment, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in the present disclosure. The hardware components may also access, manipulate, process, create, and store data in response to execution of the instructions or software. For example, the singular term “processor” or “computer” may be used in the description of the examples described in the present disclosure, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in the present disclosure are performed by computing hardware, for example, by one or more processors or computers, implemented as described above executing instructions or software to perform the operations described in the present disclosure that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example embodiment, the instructions and/or software include machine code that is directly executed by the processor or computer, such as machine code produced by a compiler. In another example, the instructions or software include higher-level code that is executed by the processor or computer using an interpreter. Persons and/or programmers of ordinary skill in the art may readily write the instructions and/or software based on the block diagrams and the flow charts illustrated in the drawings and the corresponding descriptions in this specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include at least one of read-only memory (ROM), programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to a processor or computer so that the processor or computer may execute the instructions.

While various example embodiments have been described, it will be apparent to those skilled in the art that various changes in form and detail may be made thereto without departing from the spirit and scope of the present discourse as set forth by the claims.

1. A wireless communication device, including:
a radio frequency integrated circuit (RFIC), including n signal processing modules, a switching module and n communication ports;
an antenna switch module; and
an antenna array, including m antennas,
wherein each of the n signal processing modules is configured to process a signal to be transmitted from the signal processing module and a signal that is received by the signal processing module,
wherein the switching module is configured to be connected between the n signal processing modules and the n communication ports and connect one of the n signal processing modules to one of the n communication ports,
wherein each of the n communication ports is connected to at least one of the m antennas through the antenna switch module, and n and m are integers greater than 1.

2. The wireless communication device of claim 1, wherein,
the switching module is an n-pole n-throw switching module.

3. The wireless communication device of claim 1, wherein the n communication ports include at least one of transmitting ports and transceiver ports.

4. The wireless communication device of claim 1, wherein,
a first communication port among the n communication ports is connected to a first antenna group among the m antennas through a first switch in the antenna switch module.

5. The wireless communication device of claim 4, wherein,
a second communication port among the n communication ports is connected to a second antenna group among the m antennas through a second switch in the antenna switch module.

6. The wireless communication device of claim 4, wherein in an Antenna Switch Diversity switching from a 1-1-th antenna in the first antenna group to a 1-2-th antenna in the first antenna group, the switching module connects a corresponding signal processing module among the n signal processing modules to the first communication port, and the first switch in the antenna switch module connects the first communication port to the 1-2-th antenna and disconnects the first communication port from the 1-1-th antenna.

7. The wireless communication device of claim 5, wherein in an Antenna Switch Diversity switching from a 1-1-th antenna in the first antenna group to a 2-1-th antenna in the second antenna group, the switching module connects a corresponding signal processing module among the n signal processing modules to the second communication port, and the second switch in the antenna switch module connects the second communication port to the 2-1-th antenna.

8. The wireless communication device of claim 4, wherein when an antenna used to transmit a Sounding Reference Signal is switched from a 1-1-th antenna in the first antenna group to a 1-2-th antenna in the first antenna group, the switching module connects a corresponding signal processing module among the n signal processing modules to the first communication port, and the first switch in the antenna switch module connects the first communication port to the 1-2-th antenna and disconnects the first communication port from the 1-1-th antenna.

9. The wireless communication device of claim 5, wherein when an antenna used to transmit a Sounding Reference Signal is switched from a 1-1-th antenna in the first antenna group to a 2-1-th antenna in the second antenna group, the switching module connects a corresponding signal processing module among the n signal processing modules to the second communication port, and the second switch in the antenna switch module connects the second communication port to the 2-1-th antenna.

10. The wireless communication device of claim 5, wherein,
a third communication port among the n communication ports is connected to the second antenna group among the m antennas through the second switch in the antenna switch module.

11. The wireless communication device of claim 10, wherein a radio frequency signal output from the first communication port and the second communication port is a transmission signal of a first frequency band, and a radio frequency signal output from the third communication port is a transmission signal of a second frequency band,
wherein the first frequency band is a frequency band for 5th Generation Mobile Communication Technology (5G), and the second frequency band is a frequency band for 4th Generation Mobile Communication Technology (4G).

12. The wireless communication device of claim 11, wherein when an antenna used to transmit a Sounding Reference Signal is switched from a 1-1-th antenna in the first antenna group to a 1-2-th antenna in the first antenna group, the switching module connects a corresponding signal processing module among the n signal processing modules to the first communication port, and the first switch in the antenna switch module connects the first communication port to the 1-2-th antenna and disconnects the first communication port from the 1-1-th antenna.

13. The wireless communication device of claim 11, wherein when an antenna used to transmit a Sounding Reference Signal is switched from a 1-1-th antenna in the first antenna group to a 2-1-th antenna in the second antenna group and the transmission signal of the second frequency band output from the third communication port is transmitted via a 2-2-th antenna in the second antenna group, the switching module connects a corresponding signal processing module among the n signal processing modules to the second communication port, and the second switch in the antenna switch module connects the second communication port to the 2-1-th antenna.

14. The wireless communication device of claim 11, wherein when an antenna used to transmit a Sounding Reference Signal is switched from a 1-1-th antenna in the first antenna group to a 2-2-th antenna in the second antenna group and the transmission signal of the second frequency band output from the third communication port is transmitted via the 2-2-th antenna in the second antenna group, the switching module connects a corresponding signal processing module among the n signal processing modules to the second communication port, the second switch in the antenna switch module connects the second communication port to the 2-2-th antenna, and the second switch in the antenna switch module connects the third communication port to a 2-1-th antenna in the second antenna group.

15. A method for wireless communication, including:
processing, through each of n signal processing modules, a signal to be transmitted and a signal that is received;
connecting, through a switching module, one of n signal processing modules to one of n communication ports; and
connecting, through an antenna switch module, each of the n communication ports to at least one of m antennas included in an antenna array,
wherein the n signal processing modules, the switching module and the n communication ports are included in a radio frequency integrated circuit (RFIC), and the antenna switch module and the antenna array are outside the RFIC, and
wherein n and m are integers greater than 1.

16. The method of claim 15, wherein,
the switching module is an n-pole n-throw switching module.

17. The method of claim 15, wherein the n communication ports include at least one of transmitting ports and transceiver ports.

18. The method of claim 15, wherein,
a first communication port among the n communication ports is connected to a first antenna group among the m antennas through a first switch in the antenna switch module.

19. The method of claim 18, wherein,
a second communication port among the n communication ports is connected to a second antenna group among the m antennas through a second switch in the antenna switch module.

20. The method of claim 18, wherein in an Antenna Switch Diversity switching from a 1-1-th antenna in the first antenna group to a 1-2-th antenna in the first antenna group, the switching module connects a corresponding signal processing module among the n signal processing modules to the first communication port, and the first switch in the antenna switch module connects the first communication port to the 1-2-th antenna and disconnects the first communication port from the 1-1-th antenna.

21-28. (canceled)
